(19) United States
(12) Patent Application Publication
(10) Pub. No.: US 2025/0288938 A1
(43) Pub. Date: Sep. 18, 2025

(54) HYDROCARBON TRAP, EXHAUST PURIFICATION DEVICE AND HYBRID VEHICLE

(71) Applicants: HONDA MOTOR CO., LTD., Tokyo (JP); TOSOH CORPORATION, Yamaguchi (JP)

(72) Inventors: Yuki OKU, Saitama (JP); Hiroki TAKEORI, Saitama (JP); Ryohei IKUTOMO, Saitama (JP); Takeshi MORI, Saitama (JP); Koji NEMOTO, Tokyo (JP); Yuichi MATSUO, Saitama (JP); Toyohiro USUI, Yamaguchi (JP); Naoto NAKAZAWA, Yamaguchi (JP); Ryo MITSUHASHI, Yamaguchi (JP); Keita NAKAO, Yamaguchi (JP)

(21) Appl. No.: 19/056,771

(22) Filed: Feb. 19, 2025

(30) Foreign Application Priority Data
Mar. 14, 2024 (JP) 2024-039822

(51) Int. Cl. B01D 53/04; B01D 53/94; B01J 20/02; B01J 20/04; B01J 20/18; B01J 20/28; B01J 20/30; B01J 20/34; F01N 3/10; F01N 3/20; F01N 3/28

(52) U.S. Cl. CPC B01D 53/0438; B01D 53/9445; B01J 20/0237; B01J 20/04; B01J 20/186; B01J 20/28035; B01J 20/2808; B01J 20/3085; B01J 20/3408; B01J 20/3441; F01N 3/101; F01N 3/2013; F01N 3/2803; B01D 2253/108; B01D 2253/1122; B01D 2253/308; B01D 2255/1021; B01D 2255/1023; B01D 2255/1025; B01D 2255/908; B01D 2257/404; B01D 2257/502; B01D 2257/7022; B01D 2257/7027; B01D 2258/012; B01D 2259/40096; F01N 2370/04

(57) ABSTRACT

A hydrocarbon trap to be used in the adsorption of hydrocarbons contained in the exhaust gas of an internal combustion engine is provided in which a hydrocarbon adsorbing material is supported on a surface of pores of a porous substrate, the hydrocarbon adsorbing material comprises a first zeolite capable of adsorbing olefin contained in the exhaust gas, and a second zeolite capable of adsorbing paraffin and aromatic compound contained in the exhaust gas, the first zeolite adsorbs the olefin in a first temperature range, and desorbs the olefin in a second temperature range which has higher temperature than the first temperature range, and the second zeolite desorbs the paraffin and the aromatic compound in the first temperature range, and adsorbs the paraffin and the aromatic compound in the second temperature range.

This application is based on and claims the benefit of priority from Japanese Patent Application No. 2024-039822, filed on 14 Mar. 2024, the content of which is incorporated herein by reference.

### BACKGROUND OF THE INVENTION

### Field of the Invention

The present invention relates to a hydrocarbon trap, an exhaust purification device and a hybrid vehicle.

### Related Art

Thus far, efforts with the object of a mitigation or impact reduction of climate change are continuing, and research and development into an exhaust purification device are being conducted towards this realization. The exhaust purification device is provided in the exhaust passage of an internal combustion engine, and includes a three-way catalyst; however, the three-way catalyst does not reach the activation temperature during cold start of the internal combustion engine. For this reason, in order to adsorb hydrocarbons contained in the exhaust gas, a hydrocarbon trap has been provided to the exhaust purification device. In the hydrocarbon trap, for example, a hydrocarbon adsorbing material is supported on the honeycomb substrate.

Japanese Unexamined Patent Application, Publication No. 2023-35716 discloses an exhaust purification device which is provided in an exhaust passage of an internal combustion engine, and includes a three-way catalyst and a hydrocarbon adsorbing material that adsorbs hydrocarbons contained in the exhaust gas of the internal combustion engine. Herein, the hydrocarbon adsorbing material includes a first zeolite layer consisting of a first zeolite having a silica/alumina ratio of 5 to 45, and a second zeolite layer consisting of a second zeolite having a silica/alumina ratio of 10 to 100. In addition, the first zeolite is an FAU-type zeolite or a BEA-type zeolite ion exchanged by Cu ions or Cr ions, and the second zeolite is an MFI-type zeolite, an FAU-type zeolite, a BEA-type zeolite or a YFI-type zeolite ion exchanged by Cs ions, Rb ions or K ions.
Patent Document 1: Japanese Unexamined Patent Application, Publication No. 2023-35716

### SUMMARY OF THE INVENTION

However, it is desirable to improve the adsorption rate in a predetermined temperature range of hydrocarbons contained in the exhaust gas.

The present invention has an object of providing a hydrocarbon trap capable of improving the adsorption rate in a predetermined temperature range of hydrocarbons contained in the exhaust gas.

According to a first aspect of the present invention, a hydrocarbon trap used in adsorption of hydrocarbons contained in exhaust gas of an internal combustion engine includes a hydrocarbon adsorbing material is supported on a surface of pores of a porous substrate, in which the hydrocarbon adsorbing material comprises a first zeolite capable of adsorbing olefin contained in the exhaust gas, and a second zeolite capable of adsorbing paraffin and aromatic compound contained in the exhaust gas, the first zeolite adsorbs the olefin in a first temperature range, and desorbs the olefin in a second temperature range which has higher temperature than the first temperature range, and the second zeolite desorbs the paraffin and the aromatic compound in the first temperature range, and adsorbs the paraffin and the aromatic compound in the second temperature range.

According to a second aspect of the present invention, in the hydrocarbon trap as described in the first aspect, a layer including the first zeolite and the second zeolite is formed on a surface of pores of the porous substrate, or a layer including the first zeolite and a layer including the second zeolite are laminated on the surface of pores of the porous substrate.

According to a third aspect of the present invention, in the hydrocarbon trap as described in the second aspect, the layer including the first zeolite and the layer including the second zeolite are laminated in order on the surface of pores of the porous substrate.

According to a fourth aspect of the present invention, in the hydrocarbon trap as described in any one of the first to third aspects, a ratio of the second zeolite to the first zeolite corresponds to a ratio of the paraffin and the aromatic compound to the olefin.

According to a fifth aspect of the present invention, in the hydrocarbon trap as described in any one of the first to fourth aspects, the first zeolite is a silver ion-exchange zeolite, and the second zeolite is a copper ion-exchange zeolite.

According to a sixth aspect of the present invention, in the hydrocarbon trap as described in any one of the first to fifth aspects, the first zeolite has a pore diameter less than 4 Å, and the second zeolite has a pore diameter of 4 Å or more.

According to a seventh aspect of the present invention, in the hydrocarbon trap as described in the sixth aspect, the first zeolite is a CHA-type zeolite, and the second zeolite is an FAU-type zeolite.

According to an eighth aspect of the present invention, in the hydrocarbon trap as described in any one of the first to seventh aspects, the hydrocarbon adsorbing material further includes a third zeolite capable of adsorbing paraffin and aromatic compound contained in the exhaust gas, the third zeolite adsorbs the paraffin and the aromatic compound in the first temperature range, and desorbs the paraffin and the aromatic compound in the second temperature range, and a first region including the first zeolite and the second zeolite, and a second region including the third zeolite are arranged without overlap on the surface of pores of the porous substrate.

According to a ninth aspect of the present invention, the hydrocarbon trap as described in the eighth aspect, the third zeolite is a cesium exchange zeolite.

According to a tenth aspect of the present invention, the hydrocarbon trap as described in the eighth or ninth aspect, the third zeolite has a pore diameter of 4 Å or more.

According to an eleventh aspect of the present invention, the hydrocarbon trap as described in the tenth aspect, the third zeolite is a YFI-type zeolite.

According to a twelfth aspect of the present invention, an exhaust purification device provided to an exhaust passage of an internal combustion engine includes: the hydrocarbon trap as described in any one of the first to eleventh aspects, and a three-way catalyst, in which the three-way catalyst and the hydrocarbon trap are disposed in order from an upstream side of the exhaust passage.

According to a thirteenth aspect of the present invention, the exhaust purification device as described in the twelfth aspect further includes a heater which electrically heats the hydrocarbon trap.

According to a fourteenth aspect of the present invention, a hybrid vehicle includes the exhaust purification device as described in the twelfth or thirteenth aspect.

According to the present invention, it is possible to provide a hydrocarbon trap capable of improving the adsorption rate in a predetermined temperature range of hydrocarbons contained in the exhaust gas.

### BRIEF DESCRIPTION OF THE DRAWINGS

FIG. 1 is a schematic diagram showing an example of an exhaust purification device according to the present embodiment;

FIG. 2 is a cross-sectional view showing the structure of a surface of pores in a hydrocarbon trap of FIG. 1;

FIG. 3A is a graph showing a temperature characteristic of the adsorption rate of a silver ion-exchange CHA-type zeolite and a copper ion-exchange FAU-type zeolite;

FIG. 3B is a graph showing a temperature characteristic of the adsorption rate of a silver ion-exchange CHA-type zeolite and a copper ion-exchange FAU-type zeolite;

FIG. 4 is a cross-sectional view showing a modified example of the structure of a surface of pores in the hydrocarbon trap of FIG. 1;

FIG. 5 is a graph showing a temperature characteristic of the adsorption rate of a cesium ion-exchange YFI-type zeolite;

FIG. 6 is a graph showing a temperature characteristic 1 of the adsorption rate of hydrocarbon traps according to Examples 1 to 3; and

FIG. 7 is a graph showing temperature characteristics 1 and 2 of the adsorption rate of a hydrocarbon trap according to Example 2.

### DETAILED DESCRIPTION OF THE INVENTION

Hereinafter, an embodiment of the present invention will be described while referencing the drawings.

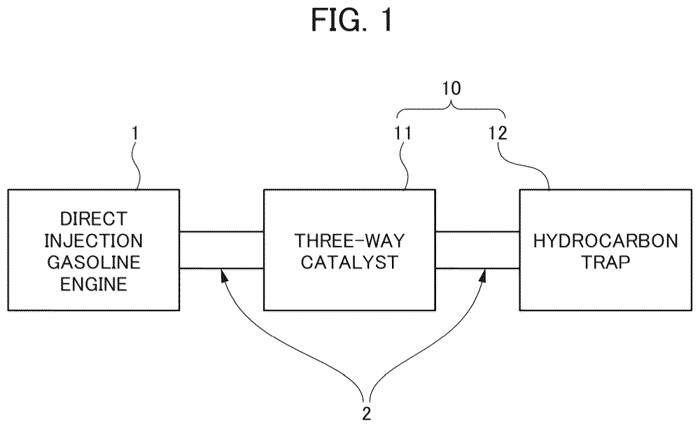

FIG. 1 shows an example of an exhaust purification device according to the present embodiment.

The exhaust purification device 10 is provided to an exhaust pipe 2 of a direct-injection gasoline engine 1 as an exhaust passage of an internal combustion engine, and includes a three-way catalyst 11, and a hydrocarbon trap 12. At this time, the three-way catalyst 11 and the hydrocarbon trap 12 are arranged in order from the upstream side of the exhaust pipe 2. Herein, the hydrocarbon trap 12 is used in the adsorption of hydrocarbons contained in the exhaust gas, and a hydrocarbon adsorbing material is supported on the surface of pores of a porous substrate.

The three-way catalyst 11 it is not particularly limited so long as able to convert hydrocarbons contained in the exhaust gas into H₂O and CO₂, CO into CO₂ and NOX into N₂. The three-way catalyst 11, for example, has a precious metal catalyst and an oxygen occlusion material supported on a honeycomb substrate. As the precious metal catalyst, for example, Pt, Pd and Rh can be exemplified. As the oxygen occlusion material, for example, CeO₂ and CeZr complex oxide can be exemplified. As the material constituting the honeycomb substrate, for example, cordierite, mullite and silicon carbide can be exemplified. The three-way catalyst 11, for example, is produced by immersion coating a slurry containing the precious metal catalyst and the oxygen occlusion material on the honeycomb substrate, and then firing.

The exhaust purification device 10 may further include a heater which electrically heats the hydrocarbon trap 12. It is thereby possible to heat the hydrocarbon trap 12 at a predetermined timing to oxidize the hydrocarbons adsorbed to the hydrocarbon trap 12.

The heater is not particularly limited so long as capable of electrically heating the hydrocarbon trap 12; however, a resistance heater can be exemplified as the heater.

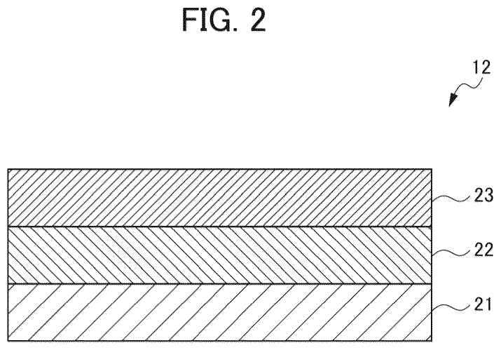

FIG. 2 shows the structure of a surface of pores in the hydrocarbon trap 12.

In the hydrocarbon trap 12, a first layer 22 containing a first zeolite, and a second layer 23 containing a second zeolite are laminated in order on the surface of partitions 21 of the honeycomb substrate as the porous substrate. At this time, partitions 21 of the honeycomb substrate divide the cells of the honeycomb substrate. Herein, the first zeolite can adsorb olefins contained in the exhaust gas, and the second zeolite can adsorb paraffins and aromatic compounds contained in the exhaust gas. The first zeolite adsorbs olefins in a first temperature range, and releases olefins in a second temperature range which has higher temperature than the first temperature range. On the other hand, the second zeolite releases paraffins and aromatic compounds in the first temperature range, and adsorbs paraffins and aromatic compounds in the second temperature range. For this reason, the adsorption rate in a predetermined temperature range including the first temperature range and the second temperature range of hydrocarbons contained in the exhaust gas improves. As a result, rapid release of hydrocarbons contained in the exhaust gas is suppressed. Herein, the zeolite generally has a temperature range of adsorbing hydrocarbons, and a temperature range of releasing hydrocarbons, in a temperature range no higher than the activation temperature of the three-way catalyst 11. For this reason, the rapid release of hydrocarbons is suppressed during cold start of the direct injection engine 1, a result of which the emission of hydrocarbons is suppressed. At this time, the exhaust purification device 10 including the hydrocarbon trap 12 is particularly effective when installed in a hybrid vehicle which frequently starts and stops the direct injection gasoline 1. It should be noted that the hydrocarbon trap 12 may have a catalytic ability of oxidizing the adsorbed olefins to CO₂ and H₂O.

At this time, since the second layer 23 which tends to be exposed to exhaust gas reaches the second temperature range before the first layer 22, the adsorption rate in the predetermined temperature range including the first temperature range and the second temperature range of hydrocarbons contained in the exhaust gas further improves.

It should be noted that the hydrocarbon trap 12 is produced as follows, for example. First, the honeycomb substrate is fired after immersing in the first slurry containing the first zeolite, a binding agent, and a solvent, to form the first layer 22 on the surface of the partitions 21 of the honeycomb substrate. Next, the honeycomb substrate on which the first layer 22 was formed on the surface of the partitions 21 is fired after immersing in a second slurry containing the second zeolite, a binding agent and a solvent to form a second layer 23 on the surface of the first layer 22. The binding agent is not particularly limited, but silica sol can be exemplified as the binding agent, for example. The solvent is not particularly limited, but water can be exemplified as the solvent, for example.

The first zeolite is not particularly limited so long as able to adsorb olefins in the first temperature range, and desorb the olefins in a second temperature range higher than the first temperature range; however, a silver ion-exchange zeolite can be exemplified as the first zeolite, for example. The second zeolite is not particularly limited so long as able to desorb paraffins and aromatic compounds in the first temperature range, and adsorb paraffins and aromatic compounds in the second temperature range; however, a copper ion-exchange zeolite can be exemplified as the second zeolite.

At this time, for the copper ion-exchange zeolite contained in the second layer 23 which tends to be exposed to the exhaust gas, in the case of H₂O being contained in the exhaust gas, the adsorptivity at high temperatures of paraffins and aromatic compounds contained in the exhaust gas improves. This is assumed to be caused by the copper ions constituting the copper ion-exchange zeolite being coated by H₂O at low temperature.

It should be noted that the copper ion-exchange zeolite has catalytic activity of oxidizing the adsorbed olefins to CO₂ and H₂O at temperatures of 300° C. and higher. In addition, by supporting the precious metal catalyst on the copper ion-exchange zeolite, the catalytic ability of the copper ion-exchange zeolite may be improved.

The pore diameter of the first zeolite is preferably less than 4 Å (angstrom). If the pore diameter of the first zeolite is less than 4 Å, the adsorptivity of olefins contained in the exhaust gas improves. The pore diameter of the first zeolite is 3 Å or more, for example. The pore diameter of the second zeolite is preferably 4 Å or more. If the pore diameter of the second zeolite is 4 Å or more, the adsorptivity of paraffins and aromatic compounds contained in the exhaust gas improves. The pore diameter of the second zeolite is less than 13 Å, for example.

The silver ion-exchange zeolite having a pore diameter of 3 Å or more and less than 4 Å is not particularly limited; however, CHA-type zeolites can be exemplified. The copper ion-exchange zeolite having a pore diameter of 4 Å or more and less than 13 Å is not particularly limited; however, FAU-type zeolites can be exemplified.

The silica/alumina ratio of the silver ion-changed CHA-type zeolite is preferably 15 or more and 45 or less, more preferably 15 or more and 35 or less, and even more preferably 21 or more and 27 or less. The ion exchange amount (Ag/Al) of the silver ion-exchange CHA-type zeolite is preferably 0.3 or more and 0.9 or less, more preferably 0.3 or more and 0.8 or less, and even more preferably 0.4 or more and 0.6 or less.

The silica/alumina ratio of the copper ion-exchange FAU-type zeolite is preferably 5 or more and 45 or less, is more preferably 10 or more and 20 or less, and is even more preferably 13 or more and 29 or less. The ion exchange amount (Cu/2Al) of the copper ion-exchange FAU-type zeolite is preferably 0.3 or more and 0.6 or less, and is more preferably 0.35 or more and 0.45 or less.

The mass ratio of the copper ion-exchange FAU-type zeolite relative to the silver ion-exchange CHA-type zeolite is preferably 1 or more and 7 or less, is more preferably 2 or more and 5 or less, and is even more preferably 2.5 or more and 3.5 or less.

At this time, the ratio of the second zeolite relative to the first zeolite preferably corresponds to the ratio of paraffins and aromatic compounds contained in the exhaust gas relative to olefins contained in the exhaust gas. For example, in the case of the ratio of the carbon equivalent concentration (ppmC) of paraffins and aromatic compounds contained in the exhaust gas relative to the olefins contained in the exhaust gas being 72/28, the mass ratio of the copper ion-exchange FAU-type zeolite relative to the silver ion-exchange CHA-type zeolite is set to 3.

The wash coat amount of hydrocarbon adsorbing material of the hydrocarbon trap 12 is preferably 120 g/L or more and 240 g/L, and is more preferably 180 g/L or more and 220 g/L or less.

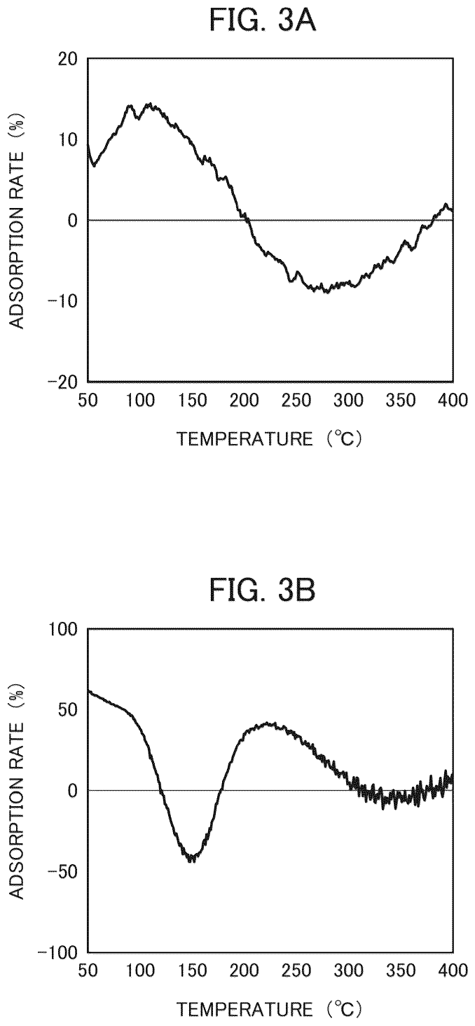

FIG. 3A and FIG. 3B respectively show the temperature characteristic of the adsorption rate of the silver ion-exchange CHA-type zeolite and copper ion-exchange FAU-type zeolite. FIG. 3 shows hydrocarbons being adsorbed when the adsorption rate is positive, and shows the hydrocarbons being desorbed when the adsorption rate is negative. In addition, the areas enclosed by the solid line having the adsorption rate of 0%, and curved lines of positive and negative adsorption rates each represent the adsorbed amount and desorbed amount.

From FIG. 3A and FIG. 3B, it is found that the silver ion-exchange CHA-type zeolite adsorbed olefins in the first temperature range (50° C. or higher and 200° C. or lower), and desorbs olefins in the second temperature range (over 200° C. and 400° C. or lower). In addition, it is found that the copper ion-exchange FAU-type zeolite desorbs paraffins and aromatic compounds in a first temperature range (120° C. or higher and 180° C. or lower), and adsorbs paraffins and aromatic compounds in the second temperature range (over 180° C. and 300° C. or lower).

In the present embodiment, the hydrocarbon trap is sufficient if the hydrocarbon adsorbing material is supported on the surface of the pores of the porous substrate, and is sufficient if the hydrocarbon adsorbing material contains the first zeolite and the second zeolite. For this reason, the hydrocarbon trap, for example, may have a single layer structure in which a layer containing the first zeolite and the second zeolite is formed on the surface of the pores of the porous substrate.

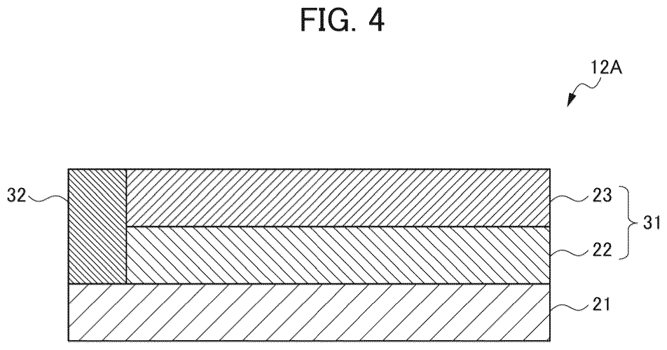

FIG. 4 shows a modified example of the structure of the surface of pores of the hydrocarbon trap.

In the hydrocarbon trap 12A, a first region 31 in which the first layer 22 containing the first zeolite and the second layer 23 containing the second zeolite are laminated in order, and a second region 32 containing a third zeolite are arranged without overlap on the surface of the partitions 21 of the honeycomb substrate. Herein, the third zeolite is able to adsorb paraffins and aromatic compounds contained in the exhaust gas. The third zeolite adsorbs paraffins and aromatic compounds in the first temperature range, and desorbs the paraffins and aromatic compounds in the second temperature range. For this reason, the adsorption rate in a predetermined temperature range including the first temperature range and the second temperature range of hydrocarbons contained in the exhaust gas further improves.

The hydrocarbon trap 12A, for example, is produced similarly to the hydrocarbon trap 12, other than using a zone coat method, for example. It should be noted that the arrangement of the first layer 22 and the second layer 23 on the surface of the partitions 21 of the honeycomb substrate is not particularly limited.

The third zeolite is not particularly limited so long as able to adsorb paraffins and aromatic compounds in the first temperature range, and desorb paraffins and aromatic compounds in the second temperature range; however, cesium ion-exchange zeolites can be exemplified as the third zeolite, for example.

The silica/alumina ratio of cesium ion-exchange zeolite is preferably 15 or more and 100 or less, and more preferably 20 or more and 42 or less. The ion exchange amount (Cs/Al) of the cesium ion-exchange zeolite is preferably 0.7 or more and 1.0 or less, and is more preferably 0.85 or more and 1.0 or less.

The pore diameter of the third zeolite is preferably 4 Å or more. When the pore diameter of the third zeolite is 4 Å or more, the adsorptivity of the paraffins and aromatic compounds contained in the exhaust gas improves. The pore diameter of the third zeolite is less than 13 Å, for example.

The cesium ion-exchange zeolite having a pore diameter of 4 Å or more and less than 13 Å is not particularly limited; however, YFI-type zeolites can be exemplified as the cesium ion-exchange zeolite.

At this time, the first region 31 in which the first layer 22 and the second layer 23 are sequentially laminated, and the second region 32 containing the third zeolite are arranged without overlap on the surface of partitions 21 of the honeycomb substrate. For this reason, migration of cesium ions to the second layer 23 during use of the hydrocarbon trap 12A is suppressed, a result of which the durability of the hydrocarbon trap 12A improves.

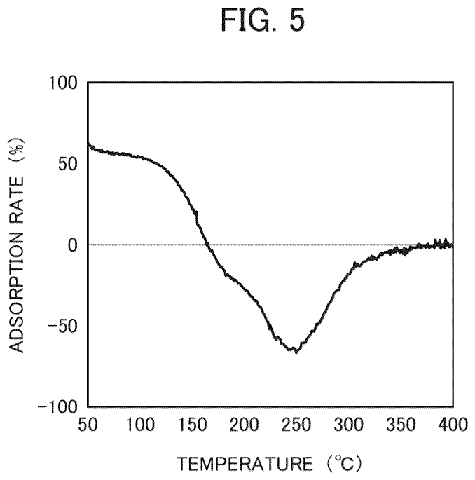

FIG. 5 shows the temperature characteristic of the adsorption rate of the cesium ion-exchange YFI-type zeolite.

From FIG. 5, it is found that the cesium ion-exchange YFI-type zeolite adsorbs paraffins and aromatic compounds in the first temperature range (50° C. or higher and 160° C. or lower), and desorbs the paraffins and aromatic compounds in the second temperature range (over 160° C. and 350° C. or lower).

Although an embodiment of the present invention have been described above, the present invention is not to be limited to the above-described embodiment, and the above-described embodiment may be modified as appropriate within the scope of the gist of the present invention. For example, the exhaust purification device 10 may have an exhaust purification filter arranged between the three-way catalyst 11 and the hydrocarbon trap 12.

### EXAMPLES

Hereinafter, examples of the present invention will be described. However, the present invention is not to be limited to the examples.

### (Honeycomb Substrate)

A 400-cell honeycomb substrate made of cordierite was used having a diameter of 25.4 mm, length of 60 mm, and volume of 30 cc.

### (First Slurry)

Using a ball mill, 100 parts by mass of a silver ion-exchange CHA-type zeolite, 50 parts by mass of silica sol and 110 parts by mass of pure water were pulverized for 12 hours to obtain the first slurry. Herein, the silver ion-exchange CHA-type zeolite has a pore diameter of 3.8 Å, silica/alumina ratio of 25, and ion exchange amount (Ag/Al) of 0.5.

### (Second Slurry)

Using a ball mill, 100 parts by mass of a copper ion-exchange FAU-type zeolite, 50 parts by mass of silica sol and 110 parts by mass of pure water were pulverized for 12 hours to obtain the second slurry. Herein, the copper ion-exchange FAU-type zeolite has a pore diameter of 7.4 Å, silica/alumina ratio of 15, and ion exchange amount (Cu/2Al) of 0.4.

### (Third Slurry)

Using a ball mill, 100 parts by mass of a cesium ion-exchange YFI-type zeolite, 50 parts by mass of silica sol and 110 parts by mass of pure water were pulverized for 12 hours to obtain the third slurry. Herein, the cesium ion-exchange YFI-type zeolite has a pore diameter of 6.2 Å, silica/alumina ratio of 20, and ion exchange amount (Cs/Al) of 1.0.

### Example 1

The honeycomb substrate was fired after immersing in the first slurry to form the first layer on the surface of the partitions of the honeycomb substrate. At this time, the wash coat amount of the silver ion-exchange CHA-type zeolite was set to 50 g/L. Next, the honeycomb substrate on which the first layer was formed on the surface of partition walls was fired after immersing in the second slurry to form the second layer on the surface of the first layer, whereby the hydrocarbon trap was obtained. At this time, the wash coat amount of the copper ion-exchange FAU-type zeolite was set to 150 g/L.

### Example 2

The honeycomb substrate was fired after immersing in the first slurry to form the first layer on the surface of the partitions of the honeycomb substrate. At this time, the wash coat amount of the silver ion-exchange CHA-type zeolite was set to 50 g/L. Next, the honeycomb substrate on which the first layer was formed on the surface of the partitions was fired after immersing in the third slurry to form the second layer on the surface of the partitions of the honeycomb substrate. At this time, the wash coat amount of the cesium ion-exchange YFI-type zeolite was set to 50 g/L. Next, the honeycomb substrate on which the second layer was formed on the surface of the first layer was fired after immersing in the second slurry to form the third layer on the surface of the second layer, whereby the hydrocarbon trap was obtained. At this time, the wash coat amount of the copper ion-exchange FAU-type zeolite was set to 100 g/L.

### Example 3

A hydrocarbon trap was obtained in the same way as Example 2, other than reversing the lamination order of the first layer and the second layer.

### (Temperature Characteristic 1 of Adsorption Rate)

Under the following conditions, the hydrocarbon trap was subjected to etching treatment for 10 hours at 850° C., while alternately switching between a rich atmosphere (80 seconds) and a lean atmosphere (20 seconds), followed by cooling to 25° C.
Rich atmosphere: C₃H₆ (1.0%), O₂ (2.5%), H₂O (10%), N₂ (balance)
Lean atmosphere: O₂ (20%), H₂O (10%), N₂ (balance)
Flowrate: 500 cc/min (1 inch diameter)

Next, after reheating the hydrocarbon trap for 10 minutes at 700° C. under an air atmosphere, it was cooled to 25° C. Next, under the following conditions, the composition of gas emitted from the hydrocarbon trap was measured while circulating a simulated exhaust gas in the hydrocarbon trap, and the temperature characteristic of the adsorption rate of the hydrocarbon trap was evaluated.

Simulated exhaust gas: NO (500 ppm), propylene (348 ppmC), isopentane (108 ppmC), toluene (408 ppmC), isooctane (336 ppmC), H₂ (0.17%), CO (0.5%), O₂ (0.49%), CO₂ (14%), H₂O (10%), N₂ (balance)
Temperature rising rate: 20° C./min
Measurement temperature: 50 to 500° C.
Flowrate: 25 L/min
Space velocity (SV): 50,000 h⁻¹

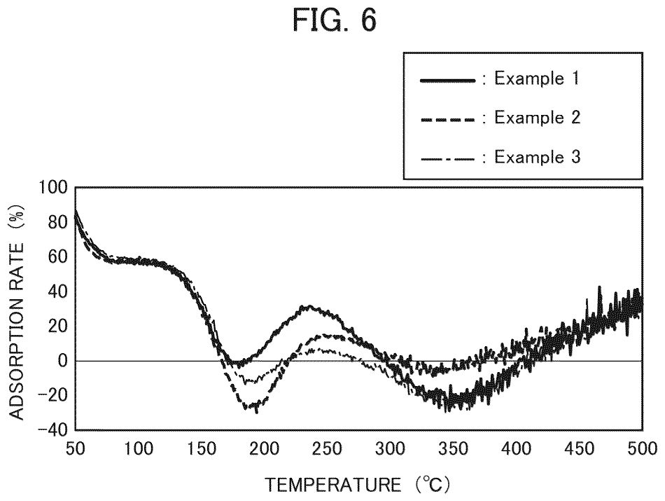

FIG. 6 shows the temperature characteristic 1 of the adsorption rate of the hydrocarbon traps according to Examples 1 to 3.

From FIG. 6, it is found that the hydrocarbon traps according to Examples 1 to 3 had high adsorption rate in the temperature range of 300° C. or lower of hydrocarbons (propylene, isopentane, toluene and isooctane) contained in the simulation exhaust gas.

### (Temperature Characteristic 2 of Adsorption Rate)

The temperature characteristic of the adsorption rate of the hydrocarbon trap was evaluated in a similar way to (temperature characteristic 1 of adsorption rate), except for changing the composition of the simulated exhaust gas as follows.

NO (500 ppm), propylene (348 ppmC), isopentane (108 ppmC), toluene (408 ppmC), isooctane (336 ppmC), H₂ (0.17%), CO (0.5%), O₂ (0.49%), CO₂ (14%), N₂ (balance)

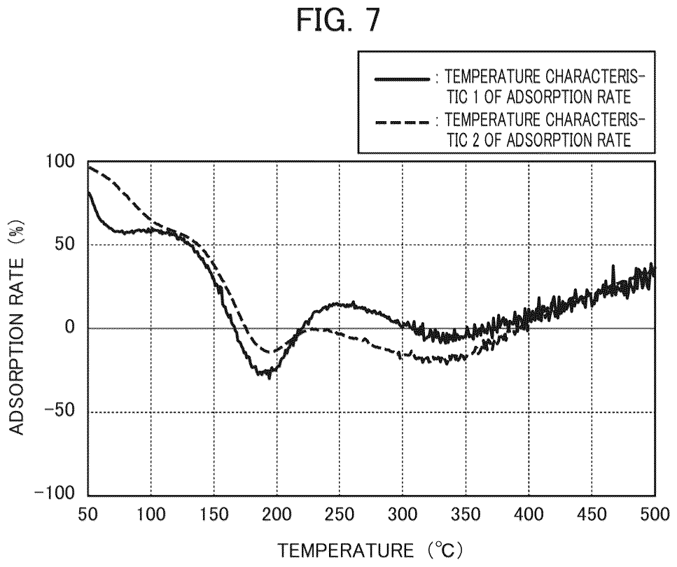

FIG. 7 shows the temperature characteristics 1 and 2 of the adsorption rate of the hydrocarbon trap according to Example 2.

From FIG. 7, it is found that, when the simulated exhaust gas contained H₂O, the hydrocarbon trap according to Example 2 had improved adsorption rate in the temperature range of 200° C. or higher of the hydrocarbons (propylene, isopentane, toluene and isooctane) contained in the simulation exhaust gas.

### EXPLANATION OF REFERENCE NUMERALS

1 direct injection gasoline engine
2 exhaust pipe
10 exhaust purification device
11 three-way catalyst
12, 12A hydrocarbon trap
21 partition of honeycomb substrate
22 first layer
23 second layer
31 first region
32 second region

What is claimed is:

1. A hydrocarbon trap to be used in adsorption of hydrocarbons contained in exhaust gas of an internal combustion engine, the hydrocarbon trap comprising:
a hydrocarbon adsorbing material which is supported on a surface of pores of a porous substrate,
wherein the hydrocarbon adsorbing material comprises a first zeolite capable of adsorbing olefin contained in the exhaust gas, and a second zeolite capable of adsorbing paraffin and aromatic compound contained in the exhaust gas,
wherein the first zeolite adsorbs the olefin in a first temperature range, and desorbs the olefin in a second temperature range which has higher temperature than the first temperature range, and
wherein the second zeolite desorbs the paraffin and the aromatic compound in the first temperature range, and adsorbs the paraffin and the aromatic compound in the second temperature range.

2. The hydrocarbon trap according to claim 1, wherein a layer including the first zeolite and the second zeolite is formed on a surface of pores of the porous substrate, or a layer including the first zeolite and a layer including the second zeolite are laminated on the surface of pores of the porous substrate.

3. The hydrocarbon trap according to claim 2, wherein the layer including the first zeolite and the layer including the second zeolite are laminated in order on the surface of pores of the porous substrate.

4. The hydrocarbon trap according to claim 1, wherein a ratio of the second zeolite to the first zeolite corresponds to a ratio of the paraffin and the aromatic compound to the olefin.

5. The hydrocarbon trap according to claim 1, wherein the first zeolite is a silver ion-exchange zeolite, and
wherein the second zeolite is a copper ion-exchange zeolite.

6. The hydrocarbon trap according to claim 1, wherein the first zeolite has a pore diameter less than 4 Å, and
wherein the second zeolite has a pore diameter of 4 Å or more.

7. The hydrocarbon trap according to claim 6, wherein the first zeolite is a CHA-type zeolite, and
wherein the second zeolite is an FAU-type zeolite.

8. The hydrocarbon trap according to claim 1, wherein the hydrocarbon adsorbing material further includes a third zeolite capable of adsorbing paraffin and aromatic compound contained in the exhaust gas,
wherein the third zeolite adsorbs the paraffin and the aromatic compound in the first temperature range, and desorbs the paraffin and the aromatic compound in the second temperature range, and
wherein a first region including the first zeolite and the second zeolite, and a second region including the third zeolite are arranged without overlap on the surface of pores of the porous substrate.

9. The hydrocarbon trap according to claim 8, wherein the third zeolite is a cesium exchange zeolite.

10. The hydrocarbon trap according to claim 8, wherein the third zeolite has a pore diameter of 4 Å or more.

11. The hydrocarbon trap according to claim 10, wherein the third zeolite is a YFI-type zeolite.

12. An exhaust purification device provided to an exhaust passage of an internal combustion engine, the exhaust purification device comprising:
the hydrocarbon trap according to claim 1, and a three-way catalyst,
wherein the three-way catalyst and the hydrocarbon trap are disposed in order from an upstream side of the exhaust passage.

13. The exhaust purification device according to claim 12, further comprising a heater which electrically heats the hydrocarbon trap.

14. A hybrid vehicle, comprising the exhaust purification device according to claim 12.
